(19) United States
(12) Patent Application Publication
(10) Pub. No.: US 2008/0103324 A1
(43) Pub. Date: May 1, 2008

(54) Method for Producing Organoalkoxydialkylsilane

(76) Inventors: Virginie Pevere, Lyon (FR); Kamel Ramdani, Tupin Et Semons (FR)

Correspondence Address: Jean-Louis Seugnet;Rhodia Inc., 8 Cedar Brook Drive, Cranbury, NJ, 08512-7500, US

(21) Appl. No.: 10/582,431

(22) PCT Filed: Dec. 10, 2004
(86) PCT No.: PCT/FR04/03185

§ 371 Date: Apr. 2, 2007

(30) Foreign Application Priority Data
Dec. 12, 2003 (FR) 0314579

(51) Int. Cl. C07F 7/18

(52) U.S. Cl. 556/471

(57) ABSTRACT

The invention relates to producing an organo alcoxydialkylsilane by a method which consists in introducing by pouring an alcanol in a dialkylhalogenosilane omega-halogenalkyl+an organic solvent (s) phase mixture and in removing a halogen acid formed by entrainment with the aid of said organic solvent(s) phase and is characterised, in particular (i) by selecting a particular phase of solvent(s), for example based on cyclohexane, (2i) by carrying out an alcanol introduction mode which makes it possible to control the drawing off the halogen acid formed during reaction and by (3i) controlling the halogen acid quantity in a reaction medium. The thus obtained dialkylhalogenosilane omega-halogenalkyl is usable, in particular as an initial product for preparing organosilisic sulphur-containing compounds of general formula (IV) by a sulfidising reaction carried out on a alkali metal polysulfur.

The present invention relates to a method of production of organoalkoxydialkylsilane by an improved method carried out on an omega-haloalkyl-dialkylhalosilane in the presence of an alkanol.

The invention relates more particularly to the manufacture of a propyl ethoxydialkylsilane from a propyl dialkylchlorosilane. Known methods for this synthesis generally use propyl alkyldichlorosilane and propyl trichloropropylsilane as reactants. The method according to the invention makes it possible to use chloropropyl-3-dimethylchlorosilane as reactant, and obtain chloropropyl-3-ethoxydimethylsilane at very high yields. The chemical reaction is as follows:

ClMe₂Si—CH₂CH₂CH₂Cl+EtOH→(EtO)Me₂Si—CH₂CH₂CH₂Cl+HCl

Ethoxylation of chloropropyl-3-dimethylchlorosilane can be carried out quantitatively and selectively in the presence of a base. For example, use of an organic base of the tertiary amine type (including triethylamine) permits stoichiometric neutralization of the acid that forms. However, the use of a base and the prolongation and complication of the process connected with its use and its final removal definitely constitute a disadvantage. However, in the absence of a base, the reaction leads to unsatisfactory performance in conditions conventionally used for this type of reaction: pouring of ethanol on a stock of chloropropyl-3-dimethylchlorosilane. This is a process in a batch reactor that only gives excellent results if the raw material is chloropropyl-3-methyldichlorosilane or chloropropyl-3-trichlorosilane: degree of transformation (TT)=100 mol. % and selectivity (RT)>95 mol. %.

In fact, the specificity of the dimethylchlorosilyl group, compared for example with the methyldichlorosilyl or trichlorosilyl group, leads to lower reactivity with respect to ethanol. In fact, this reaction is in equilibrium, and it is more difficult to shift the equilibrium toward formation of the ethoxydimethylsilyl group when using chloropropyl-3-dimethylchlorosilane. As is shown in patent WO-A-03/048169, achievement of a degree of conversion greater than 95% requires the use of a molar excess of ethanol to shift the equilibrium toward high degrees of conversion by ensuring release of the halogenated acid by distillation of the ethanol in excess relative to the chemical reaction: without release of this halogenated acid, the chemical equilibrium does not allow a TT of 80% to be exceeded with a molar excess of ethanol corresponding to a ratio of the number of moles of ethanol to the number of moles of chloropropyl-3-dimethylchlorosilane above 5. This difficulty arises from the thermodynamic properties of the ethanol-hydrochloric acid binary system, which exhibits very strong affinity; the solubility of HCl in ethanol is between 50 and 20 wt. % for temperatures between 20 and 60° C. respectively (bibliography). As mentioned above, the use of an anhydrous base overcomes this difficulty, but requires stages of filtration and regeneration of the base, making the process complex. It is important to note that the use of a large excess of ethanol, which contains several hundreds of ppm of water, gives rise to increased formation of by-products. These by-products result essentially from oligomerization of the silane function, a reaction that takes place after the reaction:

EtOH+HCl→EtCl+H₂O

2[ClMe₂Si—CH₂CH₂CH₂Cl]+H₂O→ClCH₂CH₂CH₂—SiMe₂—O—Me₂Si—CH₂CH₂CH₂Cl+HCl

It has now been found, and this is what constitutes the object of the present invention, that it is possible to achieve a further improvement of the performance obtained in the aforementioned prior art, in the reaction of alcoholysis carried out in the absence of a base, notably by adjusting the choice of solvent and the amount and control of introduction of the alcohol.

More precisely, the present invention therefore relates to a method of production of an organoalkoxydialkylsilane of formula:

R¹O—(R²R³)Si—(CH₂)₃—A (III)

+ which comprises bringing an alcohol of formula:

R¹—OH (I)

into contact with a silane of formula:

Hal—(R²R³)Si—(CH₂)₃—A (II)

in order to carry out the reaction of alcoholysis of said silane according to the following equilibrium reaction:

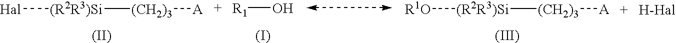

where:
the symbol Hal represents a halogen atom selected from the chlorine, bromine and iodine atoms, the chlorine atom being preferred,
the symbols R¹, which may be identical or different, each represent a monovalent hydrocarbon group selected from a linear or branched alkyl radical having from 1 to 15 carbon atoms and a linear or branched alkoxyalkyl radical having from 2 to 8 carbon atoms;
the symbols R² and R³, which may be identical or different, each represent a monovalent hydrocarbon group selected from a linear or branched alkyl radical having from 1 to 6 carbon atoms and a phenyl radical;
“A” represents a detachable group selected from: either a halogen atom Hal among the chlorine, bromine and iodine atoms, the chlorine atom being preferred; or a para-R⁰—C₆H₄—SO₂—O— radical where R⁰ is a linear or branched C₁-C₄ alkyl radical, the tosylate radical para-CH₃—C₆H₄—SO₂—O— being preferred; or an R⁰—SO₂—O— radical where R⁰ is as defined above, the mesylate radical CH₃—SO₂—O— being preferred; or an R⁰—CO—O— radical where R⁰ is as defined above, the acetate radical CH₃—CO—O— being preferred, the radical A that is the most preferred being the chlorine atom;
+ by working, under a pressure equal to or different from atmospheric pressure, in a stirred reactor equipped with a distillation column and with a condenser with possibility of reflux;
+ by carrying out, on the one hand, the said bringing into contact by pouring the alcohol of formula (I) into a mixture of silane of formula (II)+organic solvent(s) phase, it being possible for the solvent(s) phase to be used—partly—if necessary, mixed with the alcohol of formula (I), and on the other hand the removal of the halogenated acid formed of formula H—Hal by entrainment by means of said organic solvent(s) phase, and
+ by recovering the organoalkoxydialkylsilane of formula (III) formed in the reactor by any suitable method known by a person skilled in the art;
   said process being characterized by the following points:
   the mixture of silane of formula (II)+organic solvent(s) phase is heated to a temperature that corresponds to its boiling point in the pressure conditions prevailing during execution of the process, and introduction of the alcohol begins when the condenser on the reactor is charged and is operating in conditions of steady-state reflux (defined hereinafter by the expression “initial reflux conditions”);
   the solvent(s) phase comprises one or more organic solvents selected so as to be able to fulfill a dual function: on the one hand, remove the halogenated acid formed by entrainment and salting-out of the gas owing to very low affinity of said phase for the acid, and on the other hand to provide liquid-vapor equilibrium with the alcohol which provides a concentration of alcohol of formula (I) in the mixture of alcohol of formula (I)+organic solvent(s) phase in the range from 5 to 30 wt. %;
   the manner of introduction of the alcohol of formula (I) follows an operating procedure that is designed to prevent, at any moment during the reaction of alcoholysis of the silane of formula (II), accumulation of the halogenated acid of formula H—Hal in the reactor by dissolution in the alcohol of formula (I), in such a way that the amount of halogenated acid entrained by the solvent(s) phase represents, at any moment during the reaction of alcoholysis of the silane of formula (II), more than 90 wt. % of the halogenated acid formed;
   the total amount of alcohol of formula (I) introduced is such that the molar ratio of alcohol of formula (I) to silane of formula (II) is in the range from 1 to a value below 3;
   the amount of solvent(s) phase present in the reactor along with the silane of formula (II) depends on the nature of this phase and is determined so as to make it possible to limit, during introduction, the concentration of alcohol of formula (I) in the mixture of alcohol of formula (I)+organic solvent(s) phase in the aforesaid range from 5 to 30 wt. %.
   In practice, the organic solvent(s) making up the solvent(s) phase that are suitable are those selected from the group notably comprising toluene, xylene, chlorobenzene, ethylbenzene, octane, octene, hexane, cyclohexene, pentane, pentadiene, cyclopentadiene, heptane, cycloheptane, and cyclohexane.

Without being limited by the interpretation given below, it is thought that the role of the solvent(s) phase is also to make it possible to limit the alcohol content in the reaction mixture to minimize the amount of halogenated acid dissolved, which blocks the reaction, without going down to alcohol concentrations in the reaction mixture that would be insufficient to shift the chemical equilibrium.

According to a first preferred embodiment of the present invention (DP1), the solvent(s) phase comprises solvent(s) whose boiling point, in the conditions of pressure prevailing during execution of the process, is close to that of the alcohol of formula (I). The qualifier “close” is intended to signify that the difference between the boiling point of the alcohol and that of the solvent, at a given pressure, does not exceed a value of the order of 30 to 35° C. in absolute value.

Within the scope of the first embodiment DP1, when the method is carried out using an alkanol of formula (I) where R¹ is selected from the methyl, ethyl, n-propyl and isopropyl radicals, the solvent or solvents that is/are very suitable (DP1+) is/are selected from hexane, heptane and cyclohexane, used alone or mixed together and/or mixed with pentane.

Regarding the manner of introduction of the alcohol of formula (I), it can be stated that the alcohol can be introduced either in batch mode (period of pouring then period of maintaining under total reflux), or continuously at a flow rate to ensure appropriate adjustment between the rate of discharge of the halogenated acid and the chemical reaction, with this flow rate decreasing as a function of the reaction time, and thus decreasing as the reaction proceeds and with increasing difficulty in shifting the equilibrium.

According to a second preferred embodiment of the present invention (DP2), a first variant (VA1) of the manner of introduction of the alcohol of formula (I) employs the batch operating mode (DP2-VA1) comprising:
at least two charges of two fractions of alcohol, the first fraction of alcohol corresponding to a proportion representing 60 to 90 mol. % relative to the total molar quantity of alcohol used for reaching a degree of transformation (TT) of the silane of formula (II) equal to at least 96 mol. %;
at least two periods of reflux without charging, each of them subsequent to each alcohol charge effected (the expression “period of reflux without charging” means a period following the end of charging of alcohol, during which the reaction mixture is kept stirred at a temperature enabling at least the initial reflux conditions to be maintained);
the flow rate and the charging time of each fraction of alcohol as well as the duration of each period of reflux without charging being controlled in such a way that each fraction of alcohol charged is consumed during the period of reflux without charging that follows said charging.

A second variant (VA2) of the manner of introduction of the alcohol of formula (I) employs the continuous operating procedure (DP2-VA2) which comprises carrying out a single continuous charging of alcohol, but using a flow rate that decreases with the degree of advancement of the reaction of alcoholysis of the silane of formula (II) in such a way that the rate of introduction of the alcohol tracks (i.e. at each moment is roughly equal to) its rate of consumption, and this single charging stage can be extended by a period of reflux without charging of variable duration to end the reaction.

Within the scope of the second embodiment DP2, a first variant of the manner of introduction of the alcohol that is very suitable (DP2-VA1+) comprises:

1) a first charging of a first fraction of alcohol corresponding to a proportion representing 70-80 mol. % relative to the total molar quantity of alcohol used, this first charging being carried out with a flow rate of alcohol in the range from 0.03 to 0.3 mol/min of alcohol per kg of silane of formula (II) and for a duration representing 15-25% of the total duration required for consumption of the total quantity of alcohol introduced according to the aforementioned reaction scheme (this total duration can easily be determined by a person skilled in the art on the basis of investigations of appropriate chemical kinetics; this duration is for example of the order of 250 to 400 minutes in the case of the reaction of ethanol with chloropropyl-3-dimethylchlorosilane carried out under atmospheric pressure at a temperature in the range from 75 to 95° C.);

2) a first period of reflux without charging, carried out for a duration representing 25-35% of the total duration required, as defined above;

3) a second charging of a second fraction of alcohol corresponding to a proportion representing 30 to 20 mol. % relative to the total molar quantity of alcohol used, this second charging being carried out with a flow rate of alcohol in the range from 0.001 to 0.01 mol/min of alcohol per kg of silane and for a duration representing 10 to 20% of the total duration required; and

4) a second period of reflux without charging, carried out for a duration representing 30-50% of the total duration required.

Within the scope of the second embodiment DP2, a second variant of the manner of introduction of the alcohol that is very suitable (DP2-VA2+) comprises carrying out the single charging with a continuous decrease in flow rate, carried out according to at least one stage as indicated hereunder:
a single stage with a programmed decrease in flow rate from 0.2 (initial flow rate) to 0 mol/min of alcohol per kg of silane throughout the time required for consumption of the total quantity of alcohol introduced;
several stages carried out for example as follows:
a first stage with a programmed decrease in flow rate from 0.2 (initial flow rate) to 0.03 (final flow rate) mol/min of alcohol per kg of silane for a duration representing 15-25% of the total time required for consumption of the total quantity of alcohol introduced;
a second stage with a programmed decrease in flow rate from 0.03 (initial flow rate) to 0.01 (final flow rate) mol/min of alcohol per kg of silane during a time representing 25 to 35% of the total time required; and
a third stage with a programmed decrease in flow rate from 0.01 (initial flow rate) to 0 (final flow rate) mol/min of alcohol per kg of silane during a time representing 40 to 60% of the total time required;
   with the possibility, at the end of the third stage, of carrying out a period of reflux without charging for a time representing at most 20% of the total time required.

According to a third preferred embodiment of the present invention (DP3), an anhydrous alcohol containing less than 1000 ppm of water is used, and the total quantity of alcohol of formula (I) introduced [for example at the end of the charges (for VA1) or at the end of the single charging (for VA2)] is such that the molar ratio of alcohol of formula (I) to silane of formula (II) is in the range from 1.05 to 2.5.

According to a fourth preferred embodiment of the present invention (DP4), the amount of solvent(s) phase used is determined so as to give a concentration of alcohol of formula (I) in the mixture of alcohol of formula (I)+solvent(s) phase that is in the range from 10 to 30 wt. %.

Within the scope of the fourth embodiment DP4, the amount of solvent(s) phase that is very suitable (DP4+) is that which, in combination with the amounts of the other ingredients, makes it possible to satisfy the aforementioned requirements with respect to wt. %, and moreover ensures that the amount of solvent(s) represents from 45 to 55% relative to the weight of the mixture of solvent(s)+silane of formula (II).

According to a fifth preferred embodiment of the present invention (DP5), the method is carried out with reactants of formulas (I) and (II) where:
the symbol Hal represents a halogen atom selected from the chlorine, bromine and iodine atoms;
the symbols R¹ are selected from the methyl, ethyl, n-propyl, isopropyl, n-butyl, CH₃OCH₂—, CH₃OCH₂CH₂— and CH₃OCH (CH₃)CH₂— radicals;
the symbols R² and R³ are selected from the radicals: methyl, ethyl, n-propyl, isopropyl, n-butyl, n-hexyl and phenyl.

Within the scope of the fifth embodiment DP5, the method that is very suitable (DP5+) is carried out with reactants of formulas (I) and (II) where:
the symbol Hal represents a chlorine atom;
the symbols R¹ are selected from the methyl, ethyl, n-propyl and isopropyl radicals (when R¹ is ethyl for example, the alcohol used is then an alkanol comprising ethanol);
the symbols R² and R³ each represent the same methyl radical (when R¹, R² and R³=methyl and Hal=Cl, the starting silane is then chloropropyl-3-dimethylchlorosilane).

According to an embodiment of the present invention that is particularly suitable, the method is carried out using all of the preferred embodiments DP1, DP2-VA1 or DP2-VA2, DP3, DP4 and DP5 as defined previously.

According to an embodiment of the present invention that is particularly suitable, the method is carried out using the embodiments DP1, DP2-VA1, DP3, DP4 and DP5 as defined previously.

According to an embodiment of the present invention that is even more especially suitable, the method is carried out using the embodiments D1+, DP2-VA1+, DP3, DP4+ and DP5+ as defined previously.

At the end of the alcoholysis reaction, distillation of the reaction medium is carried out in order to remove the unconsumed alcohol and the solvent(s) phase.

It should be noted that it may be advantageous to carry out, if required, before this final distillation stage, a finishing stage to remove any traces of residual acidity and thus improve the degree of transformation (TT) of the silane of formula (II) (the gain in TT resulting from this finishing may reach 2% or even more) by introducing a base such as ammonia or triethylamine into the final reaction mixture.

The distillate that is collected at the end of the aforesaid distillation, comprising unconsumed alcohol of formula (I) and the solvent(s) phase, can be recycled without difficulty in a new reaction of alcoholysis. In this connection, the following sequence of operations can be used:
introduction of the distillate based on alcohol and solvent(s) obtained from a previous operation, into the reactor containing a new charge of silane of formula (II), if necessary adding fresh alcohol and/or additional solvent(s) phase so that the concentration of alcohol of formula (I) in the mixture of alcohol of formula (I)+organic solvent(s) phase is within the aforementioned range from 5 to 30 wt. %;
then heating the mixture to raise its temperature to the value corresponding to its boiling point in the conditions of pressure prevailing during execution of the method and establishment of conditions with total steady-state reflux;
then carrying out a period of reflux without charging of alcohol in the conditions explained previously in the present specification during the time required for chemical consumption of the alcohol present in the reaction mixture, it being possible for this consumption to be monitored by examining the amount of halogenated acid formed;
then charging, either in batch mode or continuously, of the extra amount of alcohol required to comply with the requirements explained above with respect to the molar ratio of alcohol of formula (I) to silane of formula (II);
then completion of the reaction as explained above by carrying out a second period of reflux without charging to reach a degree of transformation (TT) of the silane of formula (II) equal to at least 96 mol. %.

It is possible to carry out the method according to the invention by conducting the alcoholysis reaction in a reactor operating continuously, semi-continuously or in batch mode. The following are obtained: a degree of transformation (TT) of the starting silane of formula (II) that is equal to at least 96 mol. %, and a selectivity (RT) for organoalkoxydialkylsilane of formula (III) that is equal to at least 95 mol. %. By means of the present invention, the side reactions of oligomerization of the silane function by water are minimized to a considerable extent.

The organoalkoxydialkylsilane of formula (III) thus obtained can be used more especially as a starting product for the production of organosilicon compounds containing sulfur, corresponding to the average general formula (IV):

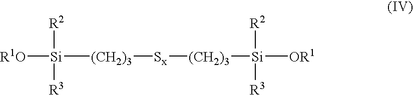

in which:
x is an integer or a fractional number, in the range from 1.5±0.1 to 5±0.1; and
the symbols R¹, R² and R³ are as defined above.

In the above formula (IV), the preferred radicals R¹ are selected from the radicals: methyl, ethyl, n-propyl, isopropyl and n-butyl; more preferably, the radicals R¹ are selected from the radicals: methyl, ethyl, n-propyl and isopropyl.

The preferred radicals R² and R³ are selected from the radicals: methyl, ethyl, n-propyl, isopropyl, n-butyl, n-hexyl and phenyl; more preferably, the radicals R² and R³ correspond to the methyl radical.

The number x, which may be an integer or a fractional number, preferably ranges from 3±0.1 to 5±0.1, and more preferably from 3.5±0.1 to 4.5±0.1.

The polysulfide monoorganooxysilanes corresponding to formula (IV) to which the present invention relates in particular are those of formula:

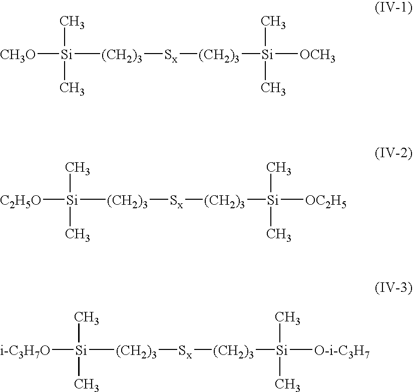

in which the symbol x is an integer or a fractional number in the range from 1.5±0.1 to 5±0.1, preferably from 3±0.1 to 5±0.1, and more preferably from 3.5±0.1 to 4.5±0.1.

In the present specification, the symbol x in formulas (IV) and (IV-1 to 3) specifically denotes an integer or a fractional number that represents the number of sulfur atoms present in a molecule of formula (IV).

In practice this number is the average of the number of sulfur atoms per molecule of the compound in question, to the extent that the chosen route of synthesis gives rise to a mixture of polysulfide products each having a different number of sulfur atoms. The polysulfide monoorganooxysilanes synthesized in fact comprise a distribution of polysulfides, ranging from monosulfide to heavier polysulfides (for example S_{≧5}), centered on an average molar value (value of the symbol x) located in the general domain (x ranging from 1.5±0.1 to 5±0.1), preferred domain (x ranging from 3±0.1 to 5±0.1) and more preferred domain (x ranging from 3.5±0.1 to 4.5±0.1) mentioned above.

The products of formula (IV) can be prepared by a method that is carried out as a sequence of the stages (a), (b) and (c), in the definition of which the detachable group A corresponds to the symbol Hal representing a halogen atom and is a chlorine atom:
+ stage (a) corresponding to the process taking place according to the equation:

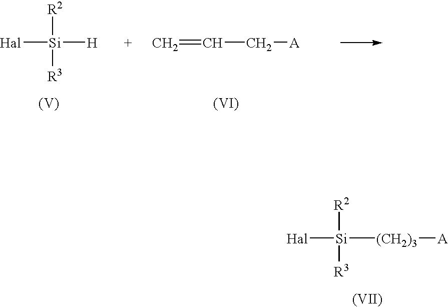

where:
   the symbol Hal represents a chlorine atom, and
   the symbols A, R² and R³ are as defined above,
      the reaction being carried out:
   by reacting, at a temperature in the range from −10° C. to 200° C., one mole of the diorganohalosilane of formula (V) with a stoichiometric or non-stoichiometric molar quantity of the allyl derivative of formula (VI), working, in a homogeneous or heterogeneous medium, in the presence of an initiator comprising:
   either a catalytic activator comprising: (i) at least one catalyst containing at least one transition metal or a derivative of said metal, taken from the group comprising Co, Ru, Rh, Pd, Ir and Pt; and optionally (2i) at least one hydrosilylation reaction promoter or auxiliary,
   or a photochemical activator, in particular comprising suitable ultraviolet radiation or suitable ionizing radiation,
      and optionally isolating the diorganohalosilylpropyl derivative of formula (VII) formed;
+ stage (b) corresponding to the process described on the preceding pages 2 to 8;
+ and stage (c) corresponding to the process employing the reaction:

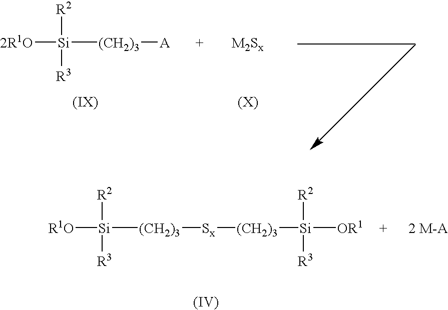

where:
the symbols R¹, R², R³, A and x are as defined above, and
the symbol M represents an alkali metal,
   the reaction being carried out:
by reacting, at a temperature in the range from 20° C. to 120° C., either the reaction mixture obtained at the end of stage (b), or the monoorganooxydiorganosilylpropyl derivative of formula (IX) used separately after separation from said reaction mixture, with the metal polysulfide of formula (X) in the anhydrous state, using 0.5±15 mol. % of metal polysulfide of formula (X) per mole of reactant of formula (IX) and optionally working in the presence of an inert polar (or nonpolar) organic solvent, and
isolating the bis-(monoorganooxysilylpropyl) polysulfide of formula (I) formed.

Stage (a) comprises reacting the diorganohalosilane of formula (V) with the allyl derivative of formula (VI) in the presence of a chosen initiator. The initiator used comprises all the initiators corresponding to the types stated above, which are effective in activating the reaction between a function ≡SiH and an ethylenic unsaturation.

According to a preferred embodiment relating to the initiator, the latter is selected from the catalytic activators. These catalytic activators comprise:
as the catalyst or catalysts (i): (i-1) at least one finely-divided elemental transition metal; and/or (i-2) a colloid of at least one transition metal; and/or (i-3) an oxide of at least one transition metal; and/or (i-4) a salt derived from at least one transition metal and an inorganic carboxylic acid; and/or (i-5) a complex of at least one transition metal provided with organic ligand(s) that can possess one or more heteroatom(s) and/or with organosilicon ligand(s); and/or (i-6) a salt as defined above where the metallic part is provided with ligand(s) as also defined above; and/or (i-7) a metallic species selected from the aforementioned species (elemental transition metal, oxide, salt, complex, complexed salt) where the transition metal is associated in this case with at least one other metal selected from the family of the elements of groups 1b, 2b, 3a, 3b, 4a, 4b, 5a, 5b, 6b, 7b, and 8 (except Co, Ru, Rh, Pd, Ir and Pt) of the periodic table as published in the Handbook of Chemistry and Physics, 65th edition, 1984-1985, CRC Press, Inc., said other metal being used in its elemental form or in a molecular form, said association possibly giving rise to a bimetallic or multimetallic species; and/or (i-8) a metallic species selected from the aforementioned species (elemental transition metal and association of transition metal—other metal; oxide, salt, complex and complexed salt based on a transition metal or based on an association of transition metal—other metal) which is supported on an inert solid support such as alumina, silica, carbon black, a clay, titanium dioxide, an aluminosilicate, a mixture of oxides of aluminum and zirconium, a polymeric resin;
as the optional promoter(s) or auxiliary/auxiliaries (2i): a compound, which can for example be in the form of a ligand or of an ionic compound, notably selected from the group comprising: an organic peroxide; a carboxylic acid; a salt of carboxylic acid; a tertiary phosphine; an amine; an amide; a linear or cyclic ketone; a trialkylhydrogensilane; benzotriazole; phenothiazine; a compound of the type trivalent metal-(C₆H₅)₃ where metal=As, Sb or P; a mixture of amine or of cyclohexanone with an organosilicon compound containing one or more ≡Si—H groups; the compounds CH₂═CH—CH₂—OH or CH₂═CH—CH₂—OCOCH₃; a lactone; a mixture of cyclohexanone with triphenylphosphine; an ionic compound, for example a nitrate or a borate of alkali metal or imidazolinium, a phosphonium halide, a quaternary ammonium halide, a tin(II) halide.

According to a more preferred embodiment relating to the initiator, the latter is selected from the preferred catalytic activators mentioned previously which contain, as the catalyst or catalysts (i), one and/or another of the metallic species (i-1) to (i-8) where the transition metal belongs to the following subgroup: Ir and Pt.

According to an even more preferred embodiment relating to the initiator, the latter is selected from the preferred catalytic activators mentioned previously which contain, as the catalyst or catalysts (i), one and/or another of the metallic species (i-1) to (i-8) where the transition metal is Ir. Within the scope of this even more preferred embodiment, Ir-based catalysts that are suitable are in particular:
[IrCl(CO)(PPh₃)₂]
[Ir(CO)H(PPh₃)₃]
[Ir(C₈H₁₂)(C₅H₅N)P(C₆H₁₁)₃]PF₆
[IrCl₃].nH₂O
H₂[IrCl₆].nH₂O
(NH₄)₂IrCl₆
Na₂IrCl₆
K₂IrCl₆
KIr(NO)Cl₅
[Ir(C₈H₁₂)₂]⁺BF₄⁻
[IrCl(CO)₃]ₙ
H₂IrCl₆
Ir₄(CO)₁₂
Ir(CO)₂(CH₃COCHCOCH₃)
Ir(CH₃COCHCOCH₃)
IrBr₃
IrCl₃
IrCl₄
IrO₂
(C₆H₇)(C₈H₁₂)Ir.

Within the scope of the even more preferred embodiment mentioned previously, other Ir-based catalysts that are even more suitable are selected from the group of the iridium complexes of formula:

[Ir(R⁴)_{y}(R⁵)]_{z} (XI)

in which:
the symbol R⁴ represents either a monodentate ligand L and in this case y=2, or a bidentate ligand (L)₂ and in this case y=1, and
the symbol R⁵ represents either Hal as defined above, and in this case z=2, or a ligand of type LX and in this case z=1.

Catalysts are very suitable which comply with the aforementioned definition in which:
R⁴ is a ligand containing at least one C═C double bond and/or at least one C≡C triple bond, and these unsaturated bonds can be conjugated or unconjugated, said ligand being linear or cyclic (mono- or polycyclic), having from 4 to 30 carbon atoms, having from 1 to 8 ethylenic and/or acetylenic unsaturations and optionally containing one or more heteroatoms, and
R⁵, besides Hal, can also represent a ligand LX such as notably a ligand derived from acetylacetone, from a β-ketoester, from a malonic ester, from an allyl compound.

Catalysts of formula (XI) where the symbol R⁵ represents Hal and z=2 are very suitable.

When iridium complexes of formula (XI) are used, it is very advantageous to add, to the reaction mixture, at least one auxiliary (2i) in the free state or supported, selected from the group of compounds comprising:
(i) the ketones,
(ii) the ethers,
(iii) the quinones,
(iv) the anhydrides,
(v) the unsaturated hydrocarbons (UHC) having an aromatic character and/or containing at least one C═C double bond and/or at least one C≡C triple bond, where these unsaturated bonds can be conjugated or unconjugated, said UHC being linear or cyclic (mono- or polycyclic), having from 4 to 30 carbon atoms, having from 1 to 8 ethylenic and/or acetylenic unsaturations and optionally containing one or more heteroatoms,
(vi) and mixtures thereof,
   with the condition that when the auxiliary comprises one or more UHC as defined above, this UHC or these UHCs is/are mixed with at least one other auxiliary different from a UHC.

In accordance with the present invention, “mixtures (vi)” of auxiliary compounds means:
(vi.1). any mixture of compounds (i) and/or (ii) and/or (iii) and/or (iv) and/or (v),
(vi.2). any compound whose molecule contains at least two different chemical functions selected from the group comprising the functions: ketone, ether, anhydride, quinone, C═C, and C≡C, characteristic of compounds (i) to (v),
(vi.3) any mixture of compounds (vi.2),
(vi.4) as well as any mixture based on at least one compound (i) to (v) and at least one compound (vi.2).

This auxiliary or these auxiliaries (i) to (vi) can be used in liquid or solid form. If they are liquid, they can be introduced into the reaction mixture in a quantity such that they perform the role of reaction solvent in addition to the role of hydrosilylation promoter. The fact that they can be used in the liquid form is a very significant operational advantage for the method of the invention. The auxiliary's optional solvent function can also make it possible, especially in the case of a heavy solvent (i.e. a solvent having a boiling point at atmospheric pressure that is above that of the compound of formula (VII), for example a polyether), to improve the stability of the reaction mixture and therefore the safety of the process. Furthermore, this offers possibilities for simple recovery of the catalyst and therefore recycling of the latter.

When the auxiliary of types (i) to (vi) is in the free state, it can be introduced into the reaction mixture at a molar ratio, relative to the iridium metal of the complex of formula (XI), of at least 0.2, and preferably of at least 1. A molar ratio greater than 10 and even greater than 100 may be selected more preferably, depending on the nature of the ligands.

In the case when the auxiliary comprises at least one compound selected from the group of the UHCs (v) used by themselves or as mixtures with one another, the concentration of catalyst of formula (XI) is such that the molar ratio iridium/silane of formula (V), expressed in moles, is less than or equal to 400.10⁻⁶, preferably less than or equal to 200.10⁻⁶ and even more preferably less than or equal to 50.10⁻⁶.

As examples of suitable ketones (i), reference may be made to those defined in U.S. Pat. No. 3,798,252 and in PL-A-176036, PL-A-174810, PL-A-145670 and JP-A-75024947.

As examples of suitable ethers (ii), reference may be made to those defined in U.S. Pat. No. 4,820,674 and in JP-A-52093718.

Advantageously, the auxiliary of types (i) to (vi) is selected from the group notably comprising: cyclohexanone, 2-cyclohexen-1-one, isophorone, 2-benzylidenecyclohexanone, 3-methylene-2-norbornanone, 4-hexen-3-one, 2-allylcyclohexanone, 2-oxo-1-cyclohexaneproprionitrile, 2-(1-cyclohexenyl)cyclohexanone, monoglyme, ethylene glycol vinyl ether, ethyl ether, benzoquinone, phenylbenzoquinone, maleic anhydride, allylsuccinic anhydride, 3-benzylidene-2,4-pentadione, phenothiazine, (methylvinyl)cyclotetrasiloxane (vinyl-D4), 4-phenyl-3-butyn-2-one, butadiene-1,3, hexadiene-1,5, cyclohexadiene-1,3, cyclooctadiene-1,5 (COD), cyclodedecatriene-1,5,9, divinyltetramethylsiloxane (DVTMS), norbornadiene and mixtures thereof.

According to a preferred embodiment of the invention, the auxiliary is a mixture (vi) containing at least one UHC (v)—preferably COD—and at least one ketone (i)—preferably cyclohexanone—and/or at least one ether (ii) and/or at least one quinone (iii). In this preferred embodiment of the method according to the invention, the concentration of catalyst of formula (XI) is such that the molar ratio iridium/silane of formula (V), expressed in moles, is less than or equal to 100.10⁻⁶, preferably less than or equal to 60.10⁻⁶, and even more preferably is between 40.10⁻⁶ and 1.10⁻⁶.

As examples of iridium complexes of formula (IV) that are particularly suitable, we may mention those corresponding to the even more preferred embodiment, in the formula of which: the symbol R⁴ is a ligand selected from butadiene-1,3, hexadiene-1,5, cyclohexadiene-1,3, cyclooctadiene-1,5 (COD), cyclododecatriene-1,5,9, divinyltetramethylsiloxane and norbornadiene.

As specific examples of iridium complexes of formula (XI) that are even more suitable, we may mention the following catalysts:
di-μ-chlorobis(η-1,5-hexadiene)diiridium,
di-μ-bromobis(η-1,5-hexadiene)diiridium,
di-μ-iodobis(η-1,5-hexadiene)diiridium,
di-μ-chlorobis(η-1,5-cyclooctadiene)diiridium,
di-μ-bromobis(η-1,5-cyclooctadiene)diiridium,
di-μ-iodobis(η-1,5-cyclooctadiene)diiridium,
di-μ-chlorobis(η-2,5-norbornadiene)diiridium,
di-μ-bromobis(η-2,5-norbornadiene)diiridium,
di-μ-iodobis(η-2,5-norbornadiene)diiridium.

The catalyst can be used, and this constitutes another preferred embodiment, in a homogeneous medium, as described in JP-B-2,938,731. In this connection, the reaction can be carried out either continuously, or semi-continuously, or in batch mode. At the end of the operation, the reaction product is separated and collected by distillation of the reaction mixture, and it is possible to recycle the catalyst by performing a new charging of reactants on a distillation residue containing the catalyst resulting from the stage of distillation of the product from the preceding operation, optionally with further addition of fresh catalyst. When using complexes, recycling of the catalyst can be improved by adding a small amount of ligand as well.

The catalyst can also be used in a heterogeneous medium. This procedure requires in particular the use of a catalyst that is supported on an inert solid support such as those defined above. With this procedure it is possible to carry out the reaction in a fixed-bed reactor operating continuously, semi-continuously or in batch mode with recycling. It is also possible to carry out the reaction in a standard stirred reactor operating continuously, semi-continuously or in batch mode.

Regarding the other reaction conditions, the reaction is carried out over a wide temperature range preferably from −10° C. to 100° C., operating under atmospheric pressure or at a pressure above atmospheric, which can reach or even exceed 20.10⁵ Pa.

The quantity of the allyl derivative of formula (VI) used is preferably from 1 to 2 mol per 1 mol of organosilicon compound. As for the quantity of catalyst(s) (i), expressed in weight of transition metal selected from the group comprising Co, Ru, Rh, Pd, Ir and Pt, it is generally in the range from 1 to 10 000 ppm, preferably from 10 to 2000 ppm and more preferably from 50 to 1000 ppm, based on the weight of organosilicon compound of formula (V). The quantity of promoter(s) (2i), when using one or more, expressed as the number of moles of promoter(s) per gram-atom of transition metal selected from the group comprising Co, Ru, Rh, Pd, Ir and Pt, is generally in the range from 0.1 to 1000, preferably from 0.2 to 500 and more preferably from 1 to 300. The diorganohalosilylpropyl derivative of formula (VII) is obtained at a molar yield equal to at least 80% based on the starting organosilicon compound of formula (V).

Regarding stage (c), and according to a preferred embodiment, the anhydrous metal polysulfides of formula (X) are prepared by reacting an alkali metal sulfide, optionally containing water of crystallization, of formula M₂S (XII) where the symbol M has the meaning given above (alkali metal), with elemental sulfur, working at a temperature in the range from 60° C. to 300° C., optionally under pressure and also optionally in the presence of an anhydrous organic solvent.

Advantageously, the alkali metal sulfide M₂S employed is the industrially available compound which is generally in the form of a hydrated sulfide; an alkali metal sulfide of this type that is very suitable is the commercially available sulfide Na₂S, which is a hydrated sulfide containing 55 to 65 wt. % of Na₂S.

According to a more preferred manner of carrying out stage (c), the anhydrous metal polysulfides of formula (X) are prepared beforehand starting from an alkali metal sulfide M₂S in the form of a hydrated sulfide, by a process that comprises the following sequence of steps (1) and (2):
step (1), involving dehydration of the hydrated alkali metal sulfide by applying a suitable method by which the water of crystallization can be removed while keeping the alkali metal sulfide in the solid state, throughout the dehydration step;
step (2), in which one mole of dehydrated alkali metal sulfide obtained is then brought into contact with n(x−1) moles of elemental sulfur, working at a temperature in the range from 20° C. to 120° C., optionally under pressure and also optionally in the presence of an anhydrous organic solvent, the aforementioned factor n being in the range from 0.8 to 1.2 and the symbol x being as defined above.

With regard to step (1), as a very suitable dehydration procedure we may mention notably drying of the hydrated alkali metal sulfide, working under a partial vacuum in the range from 1.33×10² Pa to 40×10² Pa and heating the compound to be dried at a temperature in the range from 70° C. to 85° C. at the start of drying, then raising the temperature progressively in the course of drying from the region ranging from 70° C. to 85° C. until the region ranging from 125° C. to 135° C. is reached, following a program that envisages a first temperature rise of +10° C. to +15° C. at the end of a first period varying from 1 hour to 6 hours, followed by a second temperature rise of +20° C. to +50° C. at the end of a second period varying from 1 hour to 4 hours.

With regard to step (2), as a very suitable sulfuration procedure we may mention carrying out this reaction in the presence of an anhydrous organic solvent; suitable solvents are notably the anhydrous C₁-C₄ lower aliphatic alcohols, for example anhydrous methanol or ethanol. The number of elemental sulfur atoms Sₓ in the metal polysulfide M₂Sₓ is a function of the molar ratio of S to M₂S; for example, the use of 3 mol of S (n=1 and x−1=3) per mole of M₂S gives the alkali metal tetrasulfide of formula (X) where x=4.

Returning to the execution of stage (c), the latter is carried out over a wide temperature range preferably from 50° C. to 90° C., also preferably working in the presence of an organic solvent and, in this connection, it will be advantageous to use the alcohols discussed previously in connection with the execution of step (2).

The product M-A, and in particular the halide M-Hal, formed during the reaction is generally removed at the end of this stage, for example by filtration.

The bis-(monoorganooxydiorganosilylpropyl) polysulfide of formula (I) formed is obtained at a molar yield of at least 80%, based on the starting monoorganooxydiorganosilylpropyl derivative of formula (IX).

The following examples illustrate the present invention without limiting its scope.

### EXAMPLE 1

The equipment used in this example comprises: a perfectly stirred reactor, on top of which there is a distillation column; a condenser is provided at the top of the column and is equipped with a timer for controlling the flow rate of reflux in the column. Anhydrous ethanol (water content less than 1000 ppm) is fed into the reactor by a pump and a plunge tube. The halogenated acid is recovered in a soda trap positioned after the condenser.

Initially the reactor is charged with an equal-weight mixture of chloropropyl-3-dimethylchlorosilane and cyclohexane, i.e. 300 g of chloropropyl-3-dimethylchlorosilane (1.75 mol) and 300 g of cyclohexane. The mixture is heated to its boiling point, i.e. 94° C. at atmospheric pressure. The temperature at the top of the column is 80.6° C., the boiling point of cyclohexane at atmospheric pressure. The entire vapour stream is condensed and returned to the reactor.

Once the process is in steady-state conditions (steady temperature in the column), feed of ethanol to the reactor is started. The manner of introduction of the alcohol is based on the batch operating mode VA1, comprising:
1) a first charge of a first fraction of alcohol (88.8 g or 1.93 mol) corresponding to a proportion representing 73.4 mol. % relative to the total molar quantity of alcohol used, this first charge being carried out with a flow rate of alcohol of 0.16 mol/min of alcohol per kg of silane for a time of 40 minutes (representing 18% of the total time required for achieving consumption of the total amount of alcohol introduced);
2) a first period of reflux without charging, carried out for 1 hour (representing 27% of the total time required as defined above);
3) a second charge of a second fraction of alcohol (32.2 g or 0.70 mol) corresponding to a proportion representing 26.6 mol. % relative to the total molar quantity of alcohol used, this second charge being carried out with a flow rate of alcohol of 0.08 mol/min of alcohol per kg of silane for a time of 30 minutes (representing 14% of the total time required); and
4) a second period of reflux without charging, carried out for 90 minutes (representing 40% of the total time required).

The conditions of total reflux are maintained throughout each charge and period of reflux: only the hydrochloric acid that is not condensed leaves the system and is recovered in the soda trap. The temperature in the column is 65° C., which is the temperature of the cyclohexane-ethanol azeotrope. The progress of the reaction can be monitored directly by determining the amount of hydrochloric acid degassed, by simple weighing of the soda trap throughout the reaction.

During the first period of total reflux without charging of 1 hour, a weight gain of the soda trap is observed, indicating degassing of the hydrochloric acid. During this period the TT of the starting silane increases from 70 to 88%. After one hour, there is no longer any change in the weight of the trap, and ethanol feed is restarted. At the end of the second alcohol charge, the TT of the chloropropyl-3-dimethylchlorosilane is then 92%. At the end of the second period of reflux without charging, a TT of 98.5% is reached. The molar ratio of total quantity of ethanol introduced/chloropropyl-3-dimethylchlorosilane is equal to 1.5. The total amount of hydrochloric acid recovered in the trap at the end of the second period of reflux without charging represents 93 wt. % of the quantity produced by the alcoholysis reaction.

### Finishing:

Then gaseous ammonia is fed into the reactor (0.5 g of ammonia; this quantity includes an excess of 20% relative to reaction stoichiometry) to reach a TT of 100%.

The reaction mixture thus obtained is then distilled, to remove the cyclohexane and residual ethanol. The distillate thus recovered contains 300 g of cyclohexane and 40 g of residual ethanol. The distillation residue containing the chloropropyl-3-ethoxydimethylsilane is filtered to remove the ammonium chloride formed by reaction between the ammonia and residual hydrochloric acid.

With this method the final degree of transformation of the chloropropyl-3-dimethylchlorosilane is 100%, and the selectivity for chloropropyl-3-ethoxyimethylsilane is greater than 97%. The selectivity for by-products, the dimer, stays below 2%, as a very small amount of water is introduced.

### EXAMPLE 2

The equipment used is the same as in Example 1. The initial amounts of chloropropyl-3-dimethylchlorosilane and cyclohexane are identical to those in Example 1. In contrast, the manner of introduction of the alcohol (161 g or 3.5 mol) is based on the continuous, single-charge procedure VA2 which comprises execution of the following three stages:
a first stage with a programmed decrease in flow rate from 0.2 (initial flow rate) to 0.03 (final flow rate) mol/min of alcohol per kg of silane for a time representing 20% of the total time required for consumption of the total quantity of alcohol introduced (in this case equal to 320 minutes);
a second stage with a programmed decrease in flow rate from 0.03 (initial flow rate) to 0.01 (final flow rate) mol/min of alcohol per kg of silane for a time representing 30% of the total time required; and
a third stage with a programmed decrease in flow rate from 0.01 (initial flow rate) to 0 (final flow rate) mol/min of alcohol per kg of silane for a time representing 50% of the total time required.

The molar ratio of the total quantity of ethanol introduced/chloropropyl-3-dimethylchlorosilane is equal to 2. The total quantity of hydrochloric acid recovered in the trap at the end of the third stage represents 94 wt. % of the quantity produced by the alcoholysis reaction.

In these conditions, the TT of the starting silane, at the end of the reaction, is 99.2 mol. %.

### EXAMPLE 3

In this example, a new reaction of alcoholysis is described, in which the ethanol and the cyclohexane recovered at the end of a preceding operation are recycled.

The equipment is identical to that described in Example 1. The reactor is charged with 300 g of a fresh batch of chloropropyl-3-dimethylchlorosilane, then the distillate recovered at the end of the finishing stage of Example 1 containing 300 g of cyclohexane and 40 g of ethanol.

Next, the following sequence of operations is carried out:
heating of the mixture to raise its temperature to the value corresponding to its boiling point and establish steady-state conditions of total reflux, working at atmospheric pressure;
then execution of a period of reflux without alcohol feed for 1 hour 40 minutes;
then execution of a charge of 64.4 g (1.4 mol) of ethanol at a flow rate of 0.08 mol/min of alcohol per kg of silane for 60 minutes (the molar ratio of total quantity of ethanol/chloropropyl-3-dimethylchlorosilane is equal to 1.3);
then completion of the reaction by execution of a second period of reflux without charging lasting 60 minutes.

In these conditions, a degree of transformation (TT) of the silane equal to 98.5 mol. % is reached.

1-14. (canceled)

15. A method of production of an organoalkoxydialkylsilane of formula:
R¹O—(R²R³)Si—(CH₂)₃—A (III)
comprising the steps of:
a) bringing an alcohol of formula:
R¹—OH (I)
into contact with a silane of formula:
Hal-(R²R³)Si—(CH₂)₃—A (II)
in order to carry out the reaction of alcoholysis of said silane according to the following equilibrium reaction: 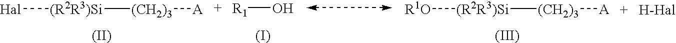
wherein:
the symbol Hal represents chlorine, bromine or iodine atoms,
the symbols R¹, which are identical or different, each represent a monovalent hydrocarbon group being a linear or branched alkyl radical having from 1 to 15 carbon atoms and a linear or a branched alkoxyalkyl radical having from 2 to 8 carbon atoms;
the symbols R² and R³, which are identical or different, each represent a monovalent hydrocarbon group being a linear or branched alkyl radical having from 1 to 6 carbon atoms or a phenyl radical;
A represents a detachable being a chlorine, bromine or iodine atom; a para-R⁰—C₆H₄—SO₂—O— radical wherein R⁰ is a linear or branched C₁-C₄ alkyl radical; a R⁰—SO₂—O— radical wherein R⁰ is as defined above; or an R⁰—CO—O— radical wherein R⁰ is as defined above;
b) working, under a pressure equal to or different from atmospheric pressure, in a stirred reactor equipped with a distillation column and with a condenser with possibility of reflux;
c) carrying out, on the one hand, the said bringing into contact of step a) by pouring the alcohol of formula (I) into a mixture of silane of formula (II)+organic solvent(s) phase, it being possible for the solvent(s) phase to be used partly, mixed with the alcohol of formula (I), and on the other hand the removal of the halogenated acid formed of formula H-Hal by entrainment by means of said organic solvent(s) phase, and
d) recovering the organoalkoxydialkylsilane of formula (III) formed in the reactor said process being characterized by the following points:
the mixture of silane of formula (II)+organic solvent(s) phase is heated to a temperature that corresponds to its boiling point in the pressure conditions prevailing during execution of the process, and introduction of the alcohol begins when the condenser on the reactor is charged and is operating in conditions of steady-state reflux;
the solvent(s) phase comprises one or more organic solvents selected so as to be able to fulfill a dual function: on the one hand, remove the halogenated acid formed by entrainment and salting-out of the gas owing to very low affinity of said phase for the acid, and on the other hand to provide liquid-vapour equilibrium with the alcohol which provides a concentration of alcohol of formula (I) in the mixture of alcohol of formula (I)+organic solvent(s) phase in the range from 5 to 30 wt. %;
the manner of introduction of the alcohol of formula (I) follows an operating procedure that is designed to prevent, at any moment during the reaction of alcoholysis of the silane of formula (II), accumulation of the halogenated acid of formula H-Hal in the reactor by dissolution in the alcohol of formula (I), in such a way that the amount of halogenated acid entrained by the solvent(s) phase represents, at any moment during the reaction of alcoholysis of the silane of formula (II), more than 90 wt. % of the halogenated acid formed;
the total amount of alcohol of formula (I) introduced is such that the molar ratio of alcohol of formula (I) to silane of formula (II) is in the range from 1 to a value below 3; and
the amount of solvent(s) phase present in the reactor along with the silane of formula (II) depends on the nature of this phase and is determined so as to make it possible to limit, during introduction, the concentration of alcohol of formula (I) in the mixture of alcohol of formula (I)+organic solvent(s) phase in the aforesaid range from 5 to 30 wt. %.

16. The method as claimed in claim 15, wherein the solvent(s) phase comprises solvent(s) whose boiling point, in the conditions of pressure prevailing during execution of the method, is close to that of the alcohol of formula (I).

17. The method as claimed in claim 15, wherein the manner of introduction of the alcohol of formula (I) is based on operating procedure VA1, comprising:
at least two charges of two fractions of alcohol, the first fraction of alcohol corresponding to a proportion representing 60 to 90 mol. % relative to the total molar quantity of alcohol used,
at least two periods of reflux without charging, each of them subsequent to each alcohol charge effected; and
the flow rate and the charging time of each fraction of alcohol as well as the duration of each period of reflux without charging being controlled in such a way that each fraction of alcohol charged is consumed during the period of reflux without charging that follows said charging.

18. The method as claimed in claim 15, wherein the manner of introduction of the alcohol of formula (I) is based on operating procedure VA2, which comprises execution of a single continuous charge of alcohol, but employing a flow rate that decreases with the degree of progress of the reaction of alcoholysis of the silane of formula (II) in such a way that the rate of introduction of the alcohol tracks its rate of consumption, and this single charging stage can be extended by a period of reflux without charging of variable duration.

19. The method as claimed in claim 15, wherein it employs an anhydrous alcohol containing less than 1000 ppm of water and the total quantity of alcohol of formula (I) introduced is such that the molar ratio of alcohol of formula (I)/silane of formula (II) is in the range from 1.05 to 2.5.

20. The method as claimed in claim 15, wherein it employs a quantity of solvent(s) phase that is determined so as to provide a concentration of alcohol of formula (I) in the combination of alcohol of formula (I)+solvent(s) phase that is in the range from 10 to 30 wt. %.

21. The method as claimed in claim 15, wherein the method is carried out with reactants of formulas (I) and (II) wherein:
the symbol Hal is a chlorine, bromine or iodine atom;
the symbols R¹ are, ethyl, n-propyl, isopropyl, n-butyl, CH₃OCH₂—, CH₃OCH₂CH₂— or CH₃OCH(CH₃)CH₂— radicals; and
the symbols R² and R³ are methyl, ethyl, n-propyl, isopropyl, n-butyl, n-hexyl or phenyl.

22. The method as claimed in claim 21, wherein R¹ is methyl, ethyl, n-propyl or isopropyl radicals, and the solvent or solvents is/are hexane, heptane, or cyclohexane used alone or mixed with pentane.

23. The method as claimed in claim 15, wherein, at the end of the alcoholysis reaction, distillation of the reaction mixture is carried out in order to remove the unconsumed alcohol and the solvent(s) phase which are optionally recycled to a new reaction of alcoholysis.

24. The method as claimed in claim 23, wherein, the unconsumed alcohol and the solvent(s) phase are recycled to a new reaction of alcoholysis and the following sequence of operations is carried out:
introduction of the distillate based on alcohol and solvent(s) obtained from a previous operation, into the reactor containing a new charge of silane of formula (II), optionally adding fresh alcohol and/or additional solvent(s) phase so that the concentration of alcohol of formula (I) in the mixture of alcohol of formula (I)+organic solvent(s) phase is within the range from 5 to 30 wt. %; then,
heating the mixture to raise its temperature to the value corresponding to its boiling point in the conditions of pressure prevailing during execution of the method and establishment of conditions with total steady-state reflux; then
carrying out a period of reflux without charging of alcohol during the time required for chemical consumption of the alcohol present in the reaction mixture; then
charging, either in batch mode or continuously, of the extra amount of alcohol required so that the molar ratio of total alcohol of formula (I) to silane of formula (II) is in the range from 1 to a value of less than 3; and, then
completion of the reaction by carrying out a second period of reflux without charging to reach a degree of transformation (TT) of the silane of formula (II) equal to at least 96 mol. %.

25. A method of production of the polysulfides of average general formula (IV): 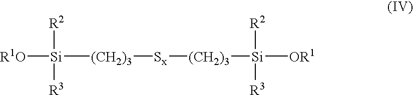
wherein:
x is an integer or a fractional number, in the range from 1.5±0.1 to 5±0.1; and
the symbols R¹, which are identical or different, each represent a monovalent hydrocarbon group being a linear or branched alkyl radical having from 1 to 15 carbon atoms and a linear or a branched alkoxyalkyl radical having from 2 to 8 carbon atoms;
the symbols R² and R³, which are identical or different, each represent a monovalent hydrocarbon group being a linear or branched alkyl radical having from 1 to 6 carbon atoms or a phenyl radical;
said method being carried out as a sequence of stages (a), (b) and (c), in the definition of which the detachable group A corresponds to the symbol Hal representing a halogen atom and is a chlorine atom:
stage (a) corresponding to the process taking place according to the equation: 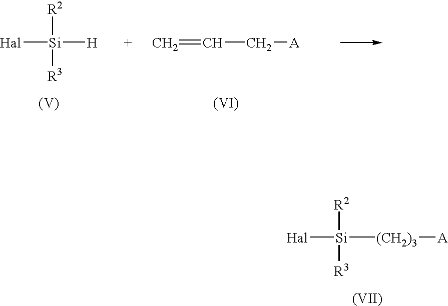
wherein:
the symbol Hal represents a chlorine atom, and
the symbols R² and R³ are as defined above, and A represents a detachable being a chlorine, bromine or iodine atom; a para-R⁰—C₆H₄—SO₂—O— radical wherein R⁰ is a linear or branched C₁-C₄ alkyl radical; a R⁰—SO₂—O— radical wherein R⁰ is as defined above; or an R⁰—CO—O— radical wherein R⁰ is as defined above;
the reaction being carried out:
by reacting, at a temperature in the range from −10° C. to 200° C., one mole of the diorganohalosilane of formula (V) with a stoichiometric or non-stoichiometric molar quantity of the allyl derivative of formula (VI), working, in a homogeneous or heterogeneous medium, in the presence of an initiator comprising:
either a catalytic activator comprising: (i) at least one catalyst containing at least one transition metal or a derivative of said metal, selected from the group consisting of Co, Ru, Rh, Pd, Ir and Pt; and optionally (2i) at least one hydrosilylation reaction promoter or auxiliary,
or a photochemical activator, optionally comprising suitable ultraviolet radiation or suitable ionizing radiation,
and optionally isolating the diorganohalosilylpropyl derivative of formula (VII) formed;
stage (b) corresponding to the process described in claim 15; and
stage (c) corresponding to the process employing the reaction: 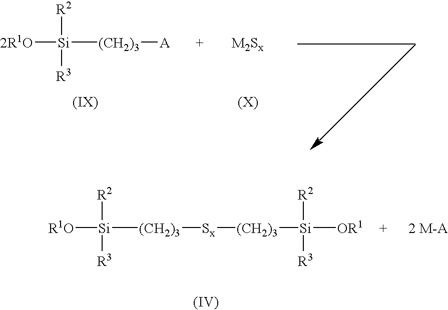
wherein:
the symbols R¹, R², R³, A and x are as defined above, and
the symbol M represents an alkali metal,
the reaction being carried out:
by reacting, at a temperature in the range from 20° C. to 120° C., either the reaction mixture obtained at the end of stage (b), or the monoorganooxydiorganosilylpropyl derivative of formula (IX) used separately after separation from said reaction mixture, with the metal polysulfide of formula (X) in the anhydrous state, using 0.5±15 mol. % of metal polysulfide of formula (X) per mole of reactant of formula (IX) and optionally working in the presence of an inert polar (or nonpolar) organic solvent, and
isolating the bis-(monoorganooxysilylpropyl) polysulfide of formula (I) formed.

26. The method as claimed in claim 25, wherein stage (a) is carried out in the presence of an activator comprising, as the catalyst or catalysts (i), one and/or another of the following metallic species: (i-1) at least one finely-divided elemental transition metal; and/or (i-2) a colloid of at least one transition metal; and/or (i-3) an oxide of at least one transition metal; and/or (i-4) a salt derived from at least one transition metal and an inorganic carboxylic acid; and/or (i-5) a complex of at least one transition metal provided with organic ligand(s) that can possess one or more heteroatom(s) and/or with organosilicon ligand(s); and/or (i-6) a salt as defined above where the metallic part is provided with ligand(s) as also defined above; and/or (i-7) a metallic species selected from the aforementioned species (elemental transition metal, oxide, salt, complex, complexed salt) where the transition metal is associated in this case with at least one other metal selected from the family of the elements of groups 1b, 2b, 3a, 3b, 4a, 4b, 5a, 5b, 6b, 7b, and 8 (except Co, Ru, Rh, Pd, Ir and Pt) of the periodic table as published in the Handbook of Chemistry and Physics, 65th edition, 1984-1985, CRC Press, Inc., said other metal being used in its elemental form or in a molecular form, said association possibly giving rise to a bimetallic or multimetallic species; and/or (i-8) a metallic species selected from the aforementioned species (elemental transition metal and association of transition metal—other metal; oxide, salt, complex and complexed salt based on a transition metal or based on an association of transition metal—other metal) which is supported on an inert solid support such as alumina, silica, carbon black, a clay, titanium dioxide, an aluminosilicate, a mixture of oxides of aluminum and zirconium, a polymeric resin.

27. The method as claimed in claim 25, wherein stage (a) is carried out in the presence of an activator comprising:
as the catalyst or catalysts (i), at least one metallic species belonging to the iridium complexes of formula:
[Ir(R⁴)_{y}(R⁵)]_{z} (XI)
in which:
the symbol R⁴ represents either a monodentate ligand L and in this case y=2, or a bidentate ligand (L)₂ and in this case y=1, and
the symbol R⁵ represents an halogen atom, and in this case z=2, or a ligand of type LX and in this case z=1;
and as the optional auxiliary or auxiliaries (2i), at least one species in the free state or supported, selected from the group of compounds consisting of:
(i) the ketones,
(ii) the ethers,
(iii) the quinones,
(iv) the anhydrides,
(v) the unsaturated hydrocarbons (UHC) having an aromatic character and/or containing at least one C═C double bond and/or at least one C≡C triple bond, where these unsaturated bonds can be conjugated or unconjugated, said UHCs being linear or cyclic (mono- or polycyclic), having from 4 to 30 carbon atoms, having from 1 to 8 ethylenic and/or acetylenic unsaturations and optionally containing one or more heteroatoms, and
(vi) and mixtures thereof,
with the condition that when the auxiliary comprises one or more UHC as defined above, this UHC or these UHCs is/are mixed with at least one other auxiliary different from a UHC.

28. The method as claimed in claim 25, wherein stage (c) is carried out using anhydrous metal polysulfides of formula (X) which are prepared beforehand from an alkali metal sulfide M₂S in the form of a hydrated sulfide, by a process involving a sequence of the following steps (1) and (2):
step (1), involving dehydration of the hydrated alkali metal sulfide by applying a suitable method by which the water of crystallization can be removed while keeping the alkali metal sulfide in the solid state, throughout the dehydration step;
step (2), in which one mole of dehydrated alkali metal sulfide obtained is then brought into contact with n(x−1) moles of elemental sulfur, working at a temperature in the range from 20° C. to 120° C., optionally under pressure and also optionally in the presence of an anhydrous organic solvent, the aforementioned factor n being in the range from 0.8 to 1.2 and the symbol x being as defined above.
